(19) United States
(12) Patent Application Publication
(10) Pub. No.: US 2021/0263205 A1
(43) Pub. Date: Aug. 26, 2021

(54) POLYMER THIN FILMS HAVING HIGH OPTICAL ANISOTROPY

(71) Applicant: Facebook Technologies, LLC, Menlo Park, CA (US)

(72) Inventors: Sheng Ye, Redmond, WA (US); Andrew John Ouderkirk, Kirkland, WA (US); Arman Boromand, Redmond, WA (US); Tanya Malhotra, Redmond, WA (US); Liliana Ruiz Diaz, Redmond, WA (US)

(21) Appl. No.: 16/984,233

(22) Filed: Aug. 4, 2020

Related U.S. Application Data
(60) Provisional application No. 62/981,833, filed on Feb. 26, 2020.

(51) Int. Cl. G02B 5/30

(52) U.S. Cl. CPC G02B 5/305; G02B 5/3083

(57) ABSTRACT

A polymer thin film is characterized by a first in-plane refractive index (nₓ) along a first direction of the polymer thin film, a second in-plane refractive index (n_{y}) along a second direction of the polymer thin film orthogonal to the first direction, and a third refractive index (n_{z}) along a thickness direction substantially orthogonal to both the first direction and the second direction, where nₓ>n_{z}>n_{y}. Such a polymer thin film may exhibit one or more of (a) an in-plane birefringence of at least approximately 0.05, and (b) nₓ greater than approximately 1.7.

### CROSS-REFERENCE TO RELATED APPLICATION

This application claims the benefit of priority under 35 U.S.C. § 119(e) of U.S. Provisional Application No. 62/981,833, filed Feb. 26, 2020, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic illustration of a process for forming a polymer thin film having a high Poisson's ratio according to some embodiments.

FIG. 2 is a schematic illustration of a method for forming a polymer thin film having a spatial gradient in the Poisson's ratio according to certain embodiments.

FIG. 3 shows a process for applying strain to a polymer thin film according to certain embodiments.

FIG. 4 is a cross-sectional schematic view of a multilayer reflective polarizer according to various embodiments.

FIG. 5 is a schematic illustration of an example optical retarder film according to some embodiments.

FIG. 6 is a schematic illustration of an example optical compensator film according to some embodiments.

FIG. 7 is a schematic illustration of a method for forming a polymer thin film having a high Poisson's ratio according to some embodiments.

FIG. 8 is a schematic illustration of a method for forming a polymer thin film having a high Poisson's ratio according to further embodiments.

FIG. 9 illustrates a lamination-based orientation process according to some embodiments.

FIG. 10 is a schematic top down plan view illustration of an example polymer thin film orientation system according to some embodiments.

FIG. 11 is a flow chart detailing a process for forming a polymerthin film having anomalous birefringence according to various embodiments.

FIG. 12 compares the performance of isotropic and birefringent material-based diffractive gratings according to certain embodiments.

FIG. 13 is a simplified perspective view of a polymer thin film having anomalous birefringence according to some embodiments.

FIG. 14 illustrates an example lamination method for forming an optically anisotropic polymer thin film according to certain embodiments.

FIG. 15 is a cross-sectional schematic view of a process for forming a multilayer reflective polarizer according to some embodiments.

FIG. 16 is a schematic illustration of a semi-crystalline polymer thin film having a spatially varying crystallite orientation according to certain embodiments.

FIG. 17 is an optical micrograph of strained polymer thin film laminates according to some embodiments.

FIG. 18 is a plot of reflectance versus wavelength for example multilayer reflective polarizers according to some embodiments.

FIG. 19 is an illustration of exemplary augmented-reality glasses that may be used in connection with embodiments of this disclosure.

FIG. 20 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown byway of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Polymer thin films exhibiting optical anisotropy may be incorporated into a variety of systems and devices, including birefringent gratings, optical compensators and optical retarders for systems using polarized light such as liquid crystal displays (LCDs), and reflective polarizers. Birefringent gratings may be used as optical combiners in augmented reality displays, for example, and as input and output couplers for waveguides and fiber optic systems. Reflective polarizers may be used in many display-related applications, particularly in pancake optical systems and for brightness enhancement within display systems that use polarized light. For orthogonally polarized light, pancake lenses may use reflective polarizers with extremely high contrast ratios for transmitted light, reflected light, or both transmitted and reflected light.

The degree of optical anisotropy achievable through conventional thin film manufacturing processes is typically limited, however, and is often exchanged for competing thin film properties such as flatness and/or film strength. For example, highly anisotropic polymer thin films often exhibit low strength in one or more in-plane directions, which may challenge manufacturability and limit throughput. Notwithstanding recent developments, it would be advantageous to provide mechanically robust, optically anisotropic polymer thin films that may be incorporated into various optical systems including display systems for artificial reality applications. The instant disclosure is thus directed generally to optically anisotropic polymer thin films and their methods of manufacture, and more specifically to polymer thin films having an anomalous birefringence.

Many applications utilize light that propagates along or substantially along a direction normal to the major surface of a polymer thin film, i.e., along the z axis. Insomuch as the grating efficiency of the polymer thin film may be determined principally by the in-plane birefringence, it may be beneficial to configure the polymer thin film such that nₓ>>n_{y}. In this regard, it will be appreciated that comparative, uniaxially-oriented polymer thin films may be characterized by nₓ>n_{y}≥n_{z}, where the in-plane birefringence (i.e., nₓ−n_{y}) is greater than approximately 0.05, e.g., approximately 0.1, approximately 0.15, or approximately 0.2, including ranges between any of the foregoing values.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. Byway of example, depending on the particular parameter, property, or condition that is substantially met, the parameter, property, or condition may be at least approximately 90% met, at least approximately 95% met, or even at least approximately 99% met.

The refractive index of a polymer thin film may be determined by its chemical composition, the chemical structure of the polymer repeat unit, its density and crystallinity, as well as the alignment of the crystals. Among these factors, the crystal alignment may dominate. As disclosed further herein, Applicants have shown that one approach to break through the birefringence limit is to provide an in-plane compression force sufficient to induce a ˜90° reorientation of crystallites within the polymer thin film. In accordance with particular embodiments, Applicants have demonstrated a polymer thin film manufacturing method that provides in-plane compression along one principal axis (e.g., along the y-axis) enabling the formation of an optically anisotropic polymer thin film where n_{z}>n_{y}. In turn, anomalously birefringent polymer thin films may be characterized by in-plane refractive indices (nₓ and n_{y}) and a through-thickness refractive index (n_{z}), where nₓ>n_{z}>n_{y}.

The formation of polymer thin films having anomalous birefringence may accompany a high Poisson's ratio in such thin films. As used herein, a polymer thin film having a “high Poisson's ratio” may, in certain examples, refer to a polymer thin film having a Poisson's ratio of greater than approximately 0.5, e.g., approximately 0.6, approximately 0.65, approximately 0.7, approximately 0.75, approximately 0.8, approximately 0.85, or approximately 0.9, including ranges between any of the foregoing values. A high Poisson's ratio polymer thin film may be amorphous or semi-crystalline. As used herein, a “semi-crystalline” polymer thin film may, in some examples, include a crystalline content of at least approximately 1%. As will be appreciated by those skilled in the art, the Poisson's ratio may describe the anisotropic properties of a material, including optical properties such as birefringence. The Poisson's ratio (v) may be defined as the ratio of the change in the width per unit width of a material to the change in its length per unit length as a result of strain. With tensile deformations considered positive and compressive deformations considered negative, Poisson's ratio may be expressed as v=−εₜ/εₙ, where εₜ is transverse strain and εₙ is longitudinal strain.

The Poisson's ratio of a polymer thin film is largely dictated by the film-forming process. For isotropic, elastic materials, the Poisson's ratio is constrained to the range −1≤v≤0.5. Moreover, most polymers exhibit a Poisson's ratio within a range of approximately 0.2 to approximately 0.3. As disclosed herein, optically anisotropic polymer thin films, including anomalously birefringent polymer thin films, may be characterized by a Poisson's ratio greater than 0.5, which enables improved performance for gratings, retarders, compensators, reflective polarizers, etc. that incorporate such thin films.

The presently disclosed polymer thin films may form, or be incorporated into, an optical element such as a birefringent grating, optical retarder, optical compensator, reflective polarizer, etc. Such optical elements may be used in various display devices, such as virtual reality (VR) and augmented reality (AR) glasses and headsets. The efficiency of these and other optical elements may depend on the degree of in-plane birefringence.

In accordance with various embodiments, a reflective polarizer may include a multilayer architecture of alternating (i.e., primary and secondary) polymer layers. In certain aspects, the primary and secondary polymer layers may be configured to have (a) refractive indices along a first in-plane direction (e.g., along the x-axis) that differ sufficiently to substantially reflect light of a first polarization state, and (b) refractive indices along a second in-plane direction (e.g., along the y-axis) orthogonal to the first in-plane direction that are matched sufficiently to substantially transmit light of a second polarization state. That is, a reflective polarizer may reflect light of a first polarization state and transmit light of a second polarization state orthogonal to the first polarization state. As used herein, “orthogonal” states may, in some examples, refer to complementary states that may or may not be related by a 90° geometry. For instance, “orthogonal” directions used to describe the length, width, and thickness dimensions of a polymer thin film may or may not be precisely orthogonal as a result of non-uniformities in the thin film.

One or more of the polymer layers, i.e., one or more primary polymer layers and/or one or more secondary polymer layers, may be characterized by a directionally-dependent refractive index. Byway of example, a primary polymer layer (or a secondary polymer layer) may have a first in-plane refractive index, a second in-plane refractive index orthogonal to and less than the first in-plane refractive index, and a third refractive index along a direction orthogonal to a major surface of the primary (or secondary) polymer layer (i.e., orthogonal to both the first in-plane refractive index and the second in-plane refractive index), where the first refractive index is greater than the third refractive index, and the third refractive index is greater than the second refractive index.

In a multilayer architecture of alternating polymer layers, each primary polymer layer and each secondary polymer layer may independently have a thickness ranging from approximately 10 nm to approximately 200 nm, e.g., 10, 20, 50, 100, 150, or 200 nm, including ranges between any of the foregoing values. A total multilayer stack thickness may range from approximately 1 micrometer to approximately 10 micrometers, e.g., 1, 2, 5, or 10 micrometers, including ranges between any of the foregoing values.

According to some embodiments, the areal dimensions (i.e., length and width) of an optically anisotropic polymer thin film may independently range from approximately 5 cm to approximately 50 cm or more, e.g., 5, 10, 20, 30, 40, or 50 cm, including ranges between any of the foregoing values. Example optically anisotropic polymer thin films may have areal dimensions of approximately 5 cm×5 cm, 10 cm×10 cm, 20 cm×20 cm, 50 cm×50 cm, 5 cm×10 cm, 10 cm×20 cm, 10 cm×50 cm, etc.

In some embodiments, a multilayer structure may be characterized by a progressive change in the thickness of each primary and secondary polymer layer pair. That is, a multilayer architecture may be characterized by an internal thickness gradient where the thickness of individual primary and secondary polymer layers within each successive pair changes continuously throughout the stack.

In various aspects, by way of example, a multilayer stack may include a first pair of primary and secondary polymer layers each having a first thickness, a second pair of primary and secondary polymer layers adjacent to the first pair each having a second thickness that is less than the first thickness, a third pair of primary and secondary polymer layers adjacent to the second pair each having a third thickness that is less than the second thickness, etc. According to certain embodiments, a thickness step for such a multilayer stack may be approximately 2 nm to approximately 20 nm, e.g., 2, 5, 10, or 20 nm, including ranges between any of the foregoing values. By way of example, a multilayer stack having a thickness gradient with a 10 nm thickness step may include a first pair of primary and secondary polymer layers each having a thickness of approximately 85 nm, a second pair of primary and secondary polymer layers adjacent to the first pair each having a thickness of approximately 75 nm, a third pair of primary and secondary polymer layers adjacent to the second pair each having a thickness of approximately 65 nm, and a fourth pair of primary and secondary polymer layers adjacent to the third pair each having a thickness of approximately 55 nm, and so on.

According to further embodiments, a multilayer stack may include alternating primary and secondary polymer layers where the thickness of each layer changes continuously throughout the stack. For instance, a multilayer stack may include a first pair of primary and secondary polymer layers, a second pair of primary and secondary polymer layers adjacent to the first pair, a third pair of primary and secondary polymer layers adjacent to the second pair, etc., where the thickness of the first primary layer is greater than the thickness of the first secondary layer, the thickness of the first secondary layer is greater than the thickness of the second primary layer, the thickness of the second primary layer is greater than the thickness of the second secondary layer, the thickness of the second secondary layer is greater than the thickness of the third primary layer, the thickness of the third primary layer is greater than the thickness of the third secondary layer, and so on.

In certain embodiments, a multilayer structure may include a stack of alternating primary polymer layers and secondary polymer layers where the primary polymer layers may exhibit a higher degree of in-plane optical anisotropy than the secondary polymer layers. For instance, the primary polymer layers may have in-plane refractive indices that differ by at least 0.2 whereas the secondary polymer layers may have in-plane refractive indices that differ by less than 0.2. In such embodiments, the primary (more optically anisotropic) polymer layers may include polyethylene naphthalate, polyethylene terephthalate, or polyethylene isophthalate, and the secondary (less optically anisotropic) polymer layers may include a co-polymer of any two of the foregoing, e.g., a PEN-PET co-polymer.

By way of example, a pancake optical system, such as a pancake lens, may include an optical element having a reflective surface and a reflective polarizer. A pancake lens may be either transmissive or reflective. According to some embodiments, a transmissive system may include a partially transparent mirrored surface and a reflective polarizer configured to reflect one handedness of circularly polarized light and transmit the other handedness of the circularly polarized light. A reflective system, on the other hand, may include a reflective polarizer configured to transmit one polarization of light, a reflector, and a quarter wave plate for converting linearly polarized light to circularly polarized light. Thus, the reflective polarizer may be a circularly polarized element such as, for example, a cholesteric reflective polarizer, or a linearly polarized element that is adapted for use with a quarter wave plate.

An optically anisotropic polymer thin film may be formed using a thin film orientation system configured to stretch a polymer thin film in one in-plane direction. For instance, a thin film orientation system may be configured to stretch a polymer thin film along one in-plane direction (e.g., along the x-axis) while constraining the thin film in an orthogonal in-plane direction (e.g., along the y-axis).

According to some embodiments, a polymer thin film may be stretched along a direction parallel to a direction of film travel through a thin film orientation system. By way of example, a polymer thin film that is initially rolled onto a source roller may be fed from the source roller at a first velocity, heated, and collected at an uptake roller operating at a second velocity greater than the first velocity such that the heated polymer thin film is stretched along its length between the source roller and the uptake roller.

According to further embodiments, a polymer thin film may be stretched transversely to a direction of film travel through a thin film orientation system. In such embodiments, a polymer thin film may be held along opposing edges by a clamping mechanism that is connected to a diverging track system such that the polymer thin film is stretched in a transverse direction (TD) as it moves along a machine direction (MD) through a deformation zone of the thin film orientation system. In certain embodiments, large scale production may be enabled, for example, using a roll-to-roll manufacturing platform.

In accordance with various embodiments, a method of forming a polymer thin film having a high Poisson's ratio may include (a) forming a polymer thin film having a polymer matrix and a plurality of crystals dispersed throughout the matrix, where the crystals are at least partially aligned with respect to an in-plane dimension of the polymer thin film, and (b) applying a tensile stress to the polymer thin film along a direction substantially orthogonal to the alignment direction of the crystals to deform the polymer thin film and realign the crystals.

The polymer matrix may include one or more of polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, polyethylene, and the like, as well as combinations, including co-polymers thereof. As used herein, the terms “polymer thin film” and “polymer layer” may be used interchangeably. The crystalline content may include polyethylene naphthalate or polyethylene terephthalate, for example, although further crystalline polymer materials are contemplated, where a crystalline phase may constitute at least approximately 1% of the polymer thin film.

In certain aspects, the tensile stress may be applied uniformly or non-uniformly along a lengthwise or widthwise dimension of the polymer thin film. Heating of the polymer thin film within an oven may accompany the application of the tensile stress. For instance, a semi-crystalline polymer thin film may be heated to a temperature greater than its glass transition temperature (T_{g}), e.g., T_{g}+10° C., T_{g}+15° C., T_{g}+20° C., T_{g}+30° C., or T_{g}+40° C., including ranges between any of the foregoing values, to facilitate deformation of the thin film and realignment of the crystals. In further aspects, the temperature during stretching may be less than the melting temperature (Tm) of the polymer thin film. In certain embodiments, the applied strain may be at least approximately 20%, e.g., approximately 20%, approximately 30%, approximately 40%, approximately 50%, approximately 100%, approximately 150%, or approximately 200%, including ranges between any of the foregoing values.

Following application of the tensile stress and deformation of the polymer thin film, the heating may be maintained for a predetermined amount of time, followed by cooling of the polymer thin film. The act of cooling may include allowing the polymer thin film to cool naturally, at a set cooling rate, or by quenching, such as by purging the oven with a low temperature gas.

Following deformation and crystal realignment, the crystals may be at least partially aligned with the direction of the applied tensile stress. In addition to the high Poisson's ratio, the deformed polymer thin film may exhibit a high degree of birefringence.

Trial 1—A biaxially stretched polyethylene naphthalate (PEN)-based thin film (T_{g}=115±5° C.) was cut into rectangular samples measuring 13 mm×25 mm. A sample was heated to and maintained at approximately 130° C. for 30 min to establish thermal equilibrium. Thereafter, the sample was stretched by applying a linear deformation profile of approximately 10 μm/s. After deformation, the sample was cooled and the areal dimensions re-measured. The average value of the Poisson's ratio for the stretched PEN film was determined to be approximately 0.8.

The optically anisotropic polymer thin films disclosed herein may be used to form multilayer reflective polarizers that may be implemented in a variety of applications. For instance, a multilayer reflective polarizer may be used to increase the polarized light output by an LED- or OLED-based display grid that includes an emitting array of monochromatic, colored, or IR pixels. In some embodiments, a reflective polarizer thin film may be applied to an emissive pixel array to provide light recycling and increased output for one or more polarization states. Moreover, highly optically anisotropic polymer thin films may decrease pixel blur in such applications.

Features from any of the embodiments described herein may be used in combination with one another in accordance with the general principles described herein. These and other embodiments, features, and advantages will be more fully understood upon reading the following detailed description in conjunction with the accompanying drawings and claims.

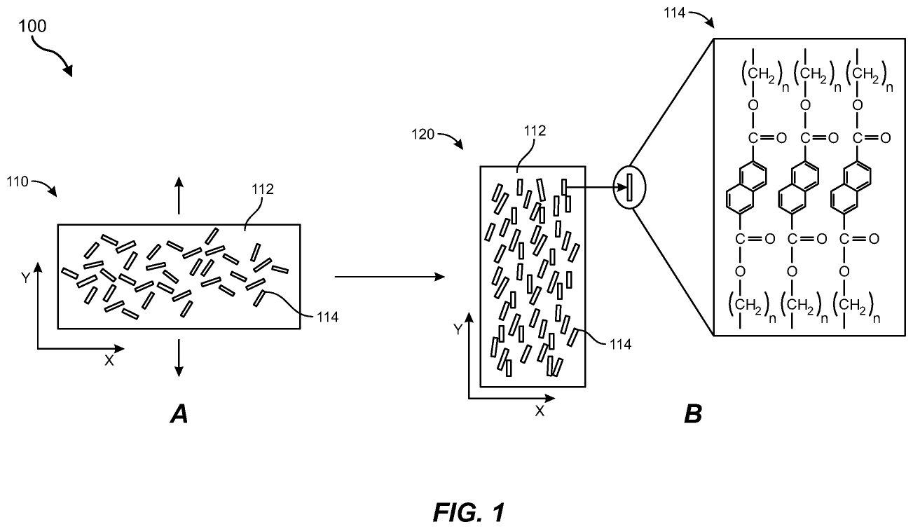

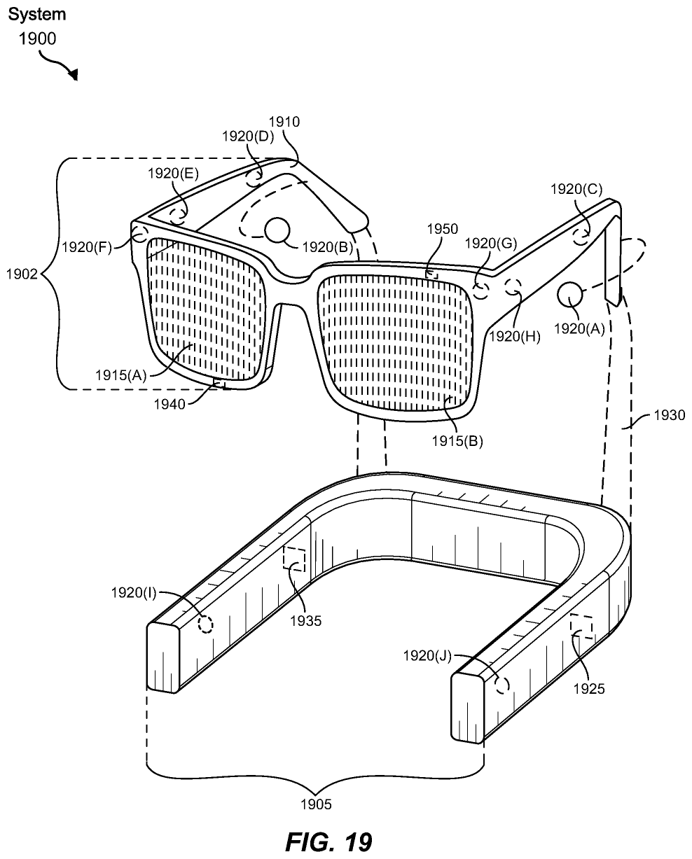

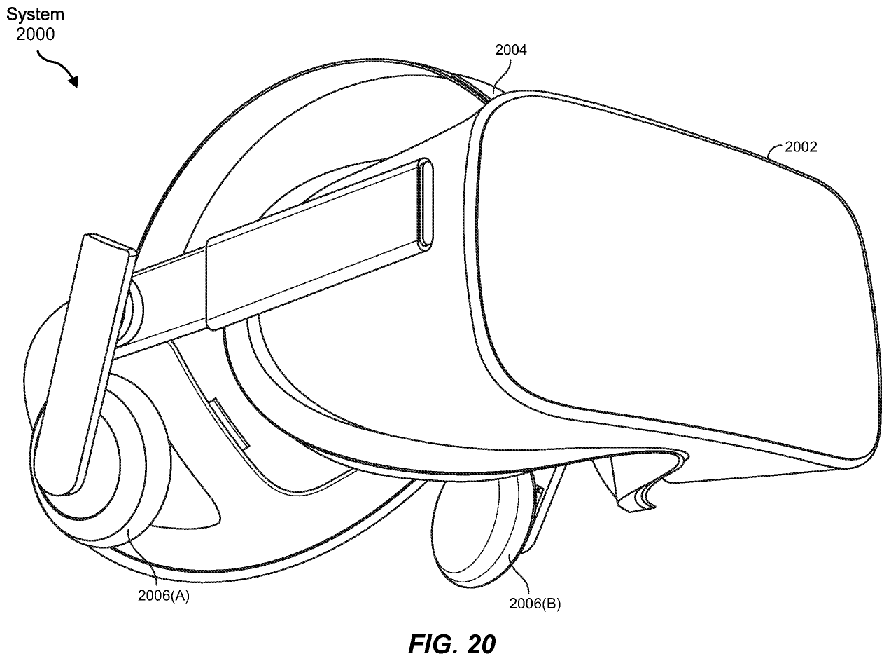

The following will provide, with reference to FIGS. 1-20, detailed descriptions of methods and systems for manufacturing optically anisotropic polymer thin films. The discussion associated with FIGS. 1-18 relates to example manufacturing methods and thin film architectures, including the optical performance of optical gratings that include birefringent polymer thin films. The discussion associated with FIGS. 19 and 20 relates to exemplary virtual reality and augmented reality devices that may include one or more optically anisotropic polymer thin films as disclosed herein.

Referring to FIG. 1, illustrated schematically is a method 100 of manufacturing a polymer thin film having a high Poisson's ratio. As shown in the top-down plan view of FIG. 1A, an anisotropic semi-crystalline polymer thin film 110 includes a polymer matrix 112 and a plurality of crystals 114 dispersed throughout the polymer matrix 112 and partially aligned along one in-plane direction of the thin film 110, e.g., along the x-axis. The initial alignment of the crystals 114 may accompany formation of the semi-crystalline polymer thin film 110 or may be achieved through one or more post-formation processes. For instance, with reference still to FIG. 1A, a casting method may be used to form a polymer thin film 110 having crystallites 114 that lie substantially within the plane of the cast film 110 (e.g., the x-y plane) and which are substantially aligned along the casting direction (e.g., along the x-axis).

The semi-crystalline polymer thin film 110 may be heated, e.g., to a temperature greater than its glass transition temperature, and stretched along a direction orthogonal to the alignment direction of the crystals 114 in FIG. 1A. For instance, in embodiments where the crystals 114 may be initially aligned with respect to the x-axis, the stretch direction may be along the y-axis. As shown in FIG. 1B, stretched anisotropic semi-crystalline polymer thin film 120 includes a polymer matrix 112 and a plurality of polymer crystals 114 that are re-aligned (re-oriented) along the y-axis, i.e., along the stretch direction, as indicated by the bold arrows in FIG. 1A. During the act of stretching and realignment, the polymer crystals 114 may fracture and re-assemble.

In certain embodiments, the stretched polymer thin film 120 may be characterized by a Poisson's ratio of greater than approximately 0.5. Furthermore, in certain embodiments, the stretched polymer thin film 120 may have a refractive index along the x-axis (nₓ) and a different refractive index along the y-axis (n_{y}), where the strain-induced optical anisotropy yields the condition nₓ<n_{y}. Alternatively, depending on the composition and structure of the polymer chains within the polymer crystals, the stretched polymer thin film 120 may be characterized by optical anisotropy where nₓ>n_{y}.

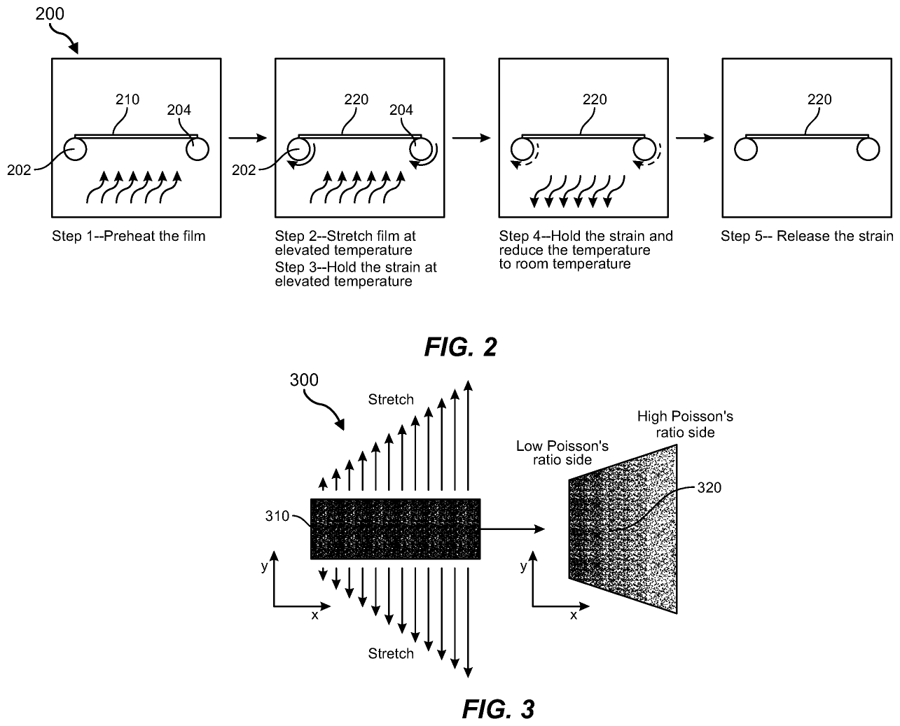

An example process for stretching a polymer thin film is illustrated in FIG. 2. Thin film stretching method 200 may include mounting a polymer thin film 210 between linear rollers 202, 204 and, in Step 1, heating the polymer thin film 210 to a temperature greater than its glass transition temperature. While maintaining the temperature of the polymer thin film, rollers 202, 204 may be engaged and the polymer thin film may be stretched. For instance, with reference to Step 2, first roller 202 may rotate at a first rate and second roller 204 may rotate at a second rate greater than the first rate to stretch the polymer thin film therebetween. In Step 3, the applied strain may be maintained at elevated temperature and, as shown in Step 4, the polymer thin film may then be cooled while maintaining the applied strain. In Step 5, the rollers may be disengaged to release the strain from the stretched polymer thin film 220.

A further example process for stretching a polymer thin film is depicted in FIG. 3. Stretching method 300 may include heating polymer thin film 310 to a temperature greater than its glass transition temperature and applying a spatially non-uniform stress along one in-plane dimension (e.g., along the y-axis), which may be orthogonal to an alignment direction of crystals (not shown) within the polymer thin film 310. As in the previous embodiment, the applied strain may be maintained at an elevated temperature prior to cooling the stretched polymer thin film 320. The stretched polymer thin film 320 may be characterized by a gradient in its Poisson's ratio, e.g., along the x-axis.

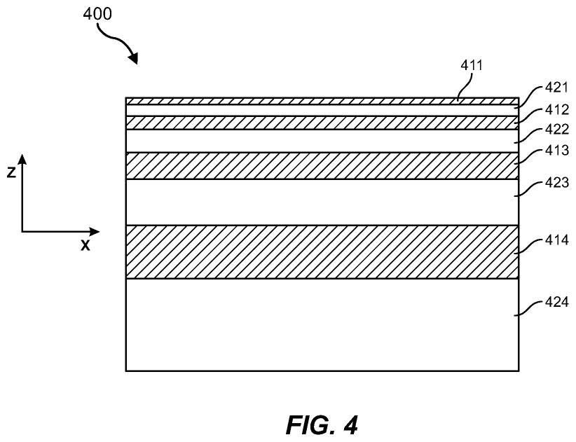

FIG. 4 is a cross-sectional view of a multilayer reflective polarizer according to various embodiments. The reflective polarizer 400 may include a stack that includes M total layers of alternating primary and secondary polymer thin films. The primary polymer thin films 411, 412, 413, 414, . . . which are collectively referred to herein as primary polymer thin films, may each include an optically anisotropic polymer thin film having a high Poisson's ratio (e.g., such as anisotropic polymer thin film 120 or anisotropic polymer thin film 320), whereas the secondary polymer thin films 421, 422, 423, 424, . . . which are collectively referred to herein as secondary polymer thin films, may each include an optically isotropic polymer thin film.

Optically anisotropic polymer layers and optically isotropic polymer layers may have different refractive indices along a first in-plane direction (e.g., x-axis direction), and refractive indices along a second in-plane direction (e.g., y-axis direction) orthogonal to the first in-plane direction that are substantially matched. Optically anisotropic polymer thin films may be characterized by an anomalous birefringence, e.g., where nₓ>n_{z}>n_{y}.

As illustrated schematically in FIG. 4, according to some embodiments, the thickness of each successive layer may increase linearly, e.g., from top to bottom, throughout the stack, which may increase the wavelength range of the associated reflectance spectrum.

Each optically anisotropic polymer layer may include, for example, polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, polyethylene, and the like, as well as combinations, including co-polymers thereof, and may be formed by stretching in accordance with the methods described herein with reference to FIGS. 1-3. Each optically isotropic polymer layer may be unstretched and may include, for example, isotropic polyesters and isotropic poly (methyl methacrylate).

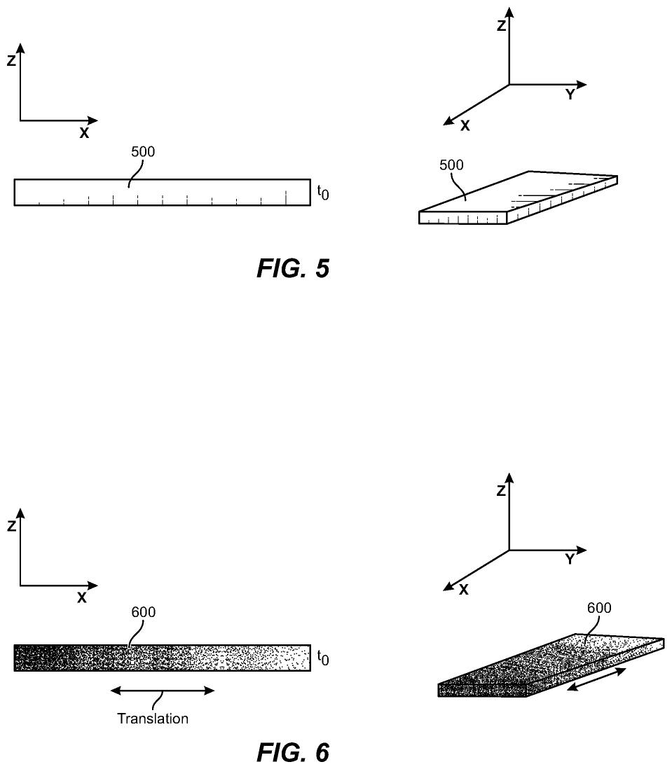

Referring to FIG. 5, shown is an example of an optical retarder film 500 having a constant thickness, tₒ. Optical retarder film 500 may include an anomalously birefringent polymer layer. When exposed to polarized light, the retardation efficiency may depend on the optical path difference (OPD), which may be given by tₒ(nₑ−nₒ), where nₑ and nₒ are the refractive indices along the extraordinary and ordinary optical axes of the retarder film 500, respectively. Optical retarder film 500 may be formed by stretching in accordance with the methods described with reference to FIG. 1 or FIG. 2.

Referring to FIG. 6, shown is an example of an optical compensator thin film 600. Optical compensator film 600 may include an anomalously birefringent polymer layer having a constant thickness to, but a spatially dependent refractive index where nₑ and nₒ may each vary as a function of position. By moving the optical compensator film 600 with respect to incident light, the optical path difference may be controlled. For instance, the optical compensator film 600 may be mounted on a translation stage and moved to tune the OPD for incident light. Optical compensator film 600 may be formed by stretching in accordance with the method described with reference to FIG. 3.

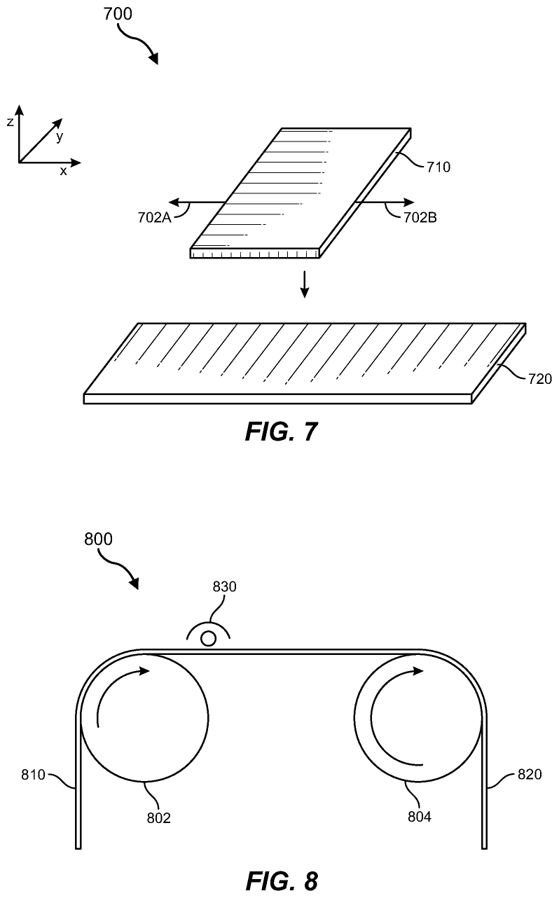

A further example method of forming a polymer thin film having a high Poisson's ratio is depicted schematically in FIG. 7. Method 700 may include applying a state of uniaxial tension to polymer thin film 710 (e.g., along x-axis directions 702A and 702B) while the polymer thin film 710 may be unconstrained in each of the y-axis and z-axis directions to form stretched polymer thin film 720.

A continuous or semi-continuous manufacturing method for forming a polymer thin film having a high Poisson's ratio is illustrated schematically in FIG. 8. According to method 800, a polymer thin film 810 may be heated and stretched between an input driver 802 and an output driver 804. In various embodiments, input driver 802 may be configured to translate the polymer thin film 810 at a first velocity and output driver 804 may be configured to translate the polymer thin film 810 at a second velocity, where the second velocity is greater than the first velocity. A heat source 830 located between the drivers 802, 804 may be used to heat the polymer thin film 810 to a temperature greater than its glass transition temperature during the stretching to form a stretched polymer thin film 820.

According to some embodiments, the orientation length (i.e., the distance between the input driver 802 and the output driver 804 or the distance between the heat source and the output driver 804) may be greater than or equal to a width of the polymer thin film 810. In certain aspects, the orientation length may be equal to the width of the polymer thin film 810, twice the width of the polymer thin film 810, three times the width of the polymer thin film 810, or four times the width of the polymer thin film 810, including ranges between any of the foregoing values. In further aspects, a ratio of the drive velocity of the output driver 804 to the drive velocity of the input driver 802 may be at least 2, i.e., 2, 3, or 4, including ranges between any of the foregoing values.

According to further embodiments, a lamination method may be used to modify the optical properties of a polymer thin film and form an optical quality polymer thin film, including an optical polymer thin film exhibiting anomalous birefringence. As used herein, an “optical” or “optical quality” polymer thin film may, in certain examples, refer to a polymer thin film having a crystalline content of up to approximately 40% transparency within the visible spectrum of at least approximately 90%, and less than approximately 10% bulk haze. For instance, an optical polymer thin film may be amorphous or may be at least approximately 1% crystalline, e.g., 1%, 2%, 5%, 10%, 15%, 20%, 25%, 30%, 35%, or 40% crystalline, including ranges between any of the foregoing values. The transparency of an optical polymer thin film within the visible spectrum may be at least approximately 90% for a polymer thin film having a thickness of at least approximately one micrometer, e.g., 90%, 95%, 97%, 98%, 99%, or 99.5% transparency, including ranges between any of the foregoing values, for a thickness of 1, 2, 5, 10, 20, 50, or 100 micrometers, including ranges between any of the foregoing values. Bulk haze within an optical polymer thin film may be less than approximately 10%, e.g., 1%, 2%, 5%, or 10%, including ranges between any of the foregoing values.

An optical polymer thin film may be characterized by birefringence, e.g., anomalous birefringence. An optical polymer thin film may be characterized by a Poisson's ratio of less than 0.5, although in some embodiments, an optical polymer thin film may be characterized by a Poisson's ratio of at least 0.5. An optical polymer thin film may include a single polymer layer or a stack of two or more polymer layers that collectively exhibit the foregoing characteristics. According to certain embodiments, an optical polymer thin film may include amorphous or semi-crystalline compositions of polyethylene naphthalate, polyethylene terephthalate, polybutylene naphthalate, or polybutylene terephthalate, as well as combinations and multilayers thereof.

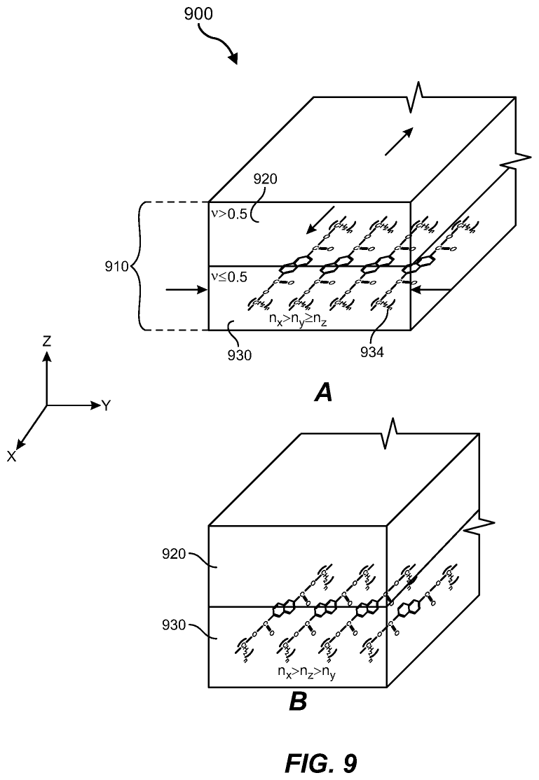

Referring to FIG. 9, method 900 may include forming a laminate 910 that includes a high Poisson's ratio polymer thin film 920 (e.g., high Poisson's ratio polymer thin film 120 or high Poisson's ratio polymer thin film 320) bonded to an optical polymer thin film 930. In some embodiments, the high Poisson's ratio polymer thin film 920 and the optical polymer thin film 930 may be formed simultaneously, such as by co-extrusion. In some embodiments, the high Poisson's ratio polymer thin film 920 and the optical polymer thin film 930 may be formed separately and then bonded to each other to form laminate 910. In still further embodiments, the high Poisson's ratio polymer thin film 920 and the optical polymer thin film 930 may be formed in succession, such as by printing the high Poisson's ratio polymer thin film 920 onto the optical polymer thin film 930, or vice versa. In the as-formed laminate, the Poisson's ratio of the high Poisson's ratio polymer thin film 920 may be greater than the Poisson's ratio of the optical polymer thin film 930. For instance, the high Poisson's ratio polymer thin film 920 may have a Poisson's ratio of approximately 0.8 and the optical polymer thin film 930 may have a Poisson's ratio of approximately 0.3.

In the illustrated method, by stretching the high Poisson's ratio polymer thin film 920, e.g., along the x-axis, the attendant transverse contraction in the high Poisson's ratio polymer thin film 920 along the y-axis may induce corresponding dimensional changes in the adjacent optical polymer thin film 930. In examples where the Poisson's ratio of the optical polymer thin film 930 is less than the Poisson's ratio of the high Poisson's ratio polymer thin film 920, the strain induced within the optical polymer thin film 930 may create lateral compression in the optical polymer thin film 930 and the formation of anomalous birefringence. In some embodiments, the laminate may be heated during the act of stretching.

Referring initially to FIG. 9A, aromatic rings within crystals 934 aligned within the optical polymer thin film 930 may, in response to the applied compressive force along the y-axis, rotate out of the x-y plane, as shown schematically in FIG. 9B. Such re-orientation of the crystalline phase may increase the refractive index along the z-axis, i.e., along the thickness dimension of the optical polymer thin film 930, and create an optical polymer thin film where nₓ>n_{z}>n_{y}. During stretching along the x-axis, the polymerthin films 920, 930 may be unconstrained in each of the orthogonal dimensions, i.e., unconstrained along the y-axis dimension and unconstrained along the z-axis dimension. Although not illustrated, after stretching, the optical polymer thin film 930 may be de-bonded or otherwise removed from the high Poisson's ratio polymer thin film 920.

In certain embodiments, the high Poisson's ratio polymer thin film 920 may be soluble in a suitable solvent, such that the high Poisson's ratio polymer thin film 920 may be removed from the optical polymer thin film 930 by dissolution. The high Poisson's ratio polymer thin film 920 may be water soluble, for example. In such an example, a high Poisson's ratio polymer thin film 920 may be printed onto an optical polymer thin film 930 to form laminate 910, which may be stretched to optically modify the optical polymer thin film 930. If desired, the high Poisson's ratio polymer thin film 920 may then be washed away.

The high Poisson's ratio polymer thin film 920 may be a homogeneous layer that overlies a selected portion or an entirety of an optical polymer thin film 930. In alternate embodiments, the high Poisson's ratio polymer thin film 920 may be a non-homogeneous layer, such as a patterned layer. A patterned layer may include a plurality of intersecting shapes such as a latticework architecture. The geometry of a patterned layer is not particularly limited and may be selected to locally or globally modify the optical properties of the optical polymer thin film 930 in accordance with desired specifications.

In the example of a latticework architecture, a patterned layer may include a plurality of intersecting rails, e.g., mullions and transoms, although the angle of intersection of such features may range from approximately 5° to approximately 90°. In some embodiments, a dimension (e.g., width) of the various features forming a patterned layer may independently range from approximately 1 micrometer to approximately 100 micrometers, e.g., approximately 1 micrometer, approximately 2 micrometers, approximately 5 micrometers, approximately 10 micrometers, approximately 20 micrometers, approximately 50 micrometers, or approximately 100 micrometers, including ranges between any of the foregoing values.

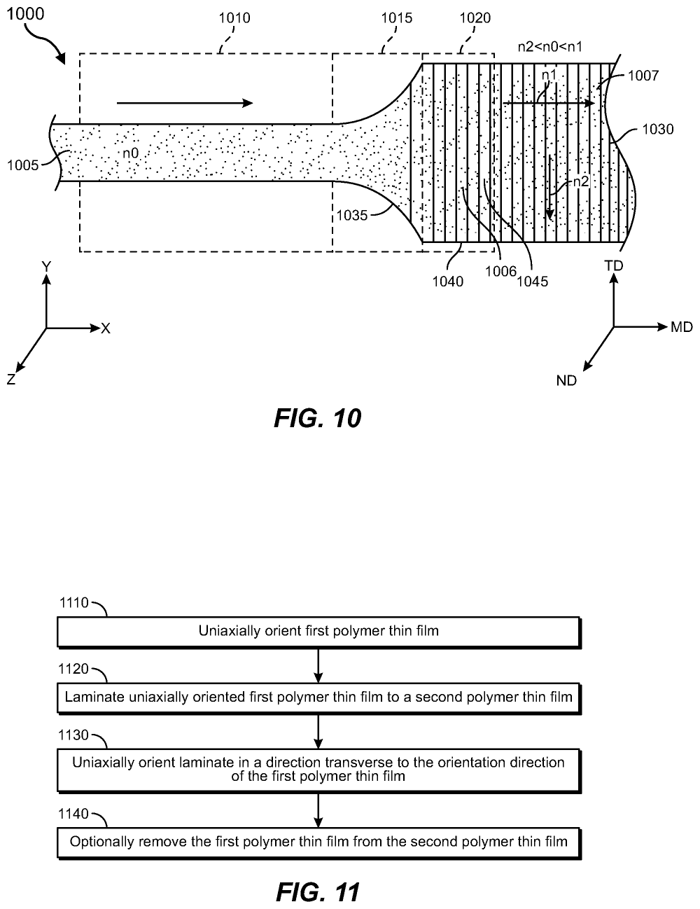

Referring to FIG. 10, shown schematically is a thin film orientation system for manufacturing an optically anisotropic polymer thin film. During operation of system 1000, a polymer thin film 1005 having an initial bulk refractive index (no) may be guided along a machine direction (MD) into pre-heating zone 1010 wherein the polymer thin film 1005 may be pre-heated to a desired temperature. A pre-heating temperature may range from approximately 80° C. to approximately 200° C., for example.

In conjunction with various embodiments, a polymer thin film (e.g., heated polymer thin film 1005) may be described with reference to three mutually orthogonal axes that are aligned with the machine direction (MD), the transverse direction (TD), and the normal direction (ND), which may correspond respectively to the length, width, and thickness dimensions of the polymer thin film.

After passing through pre-heating zone 1010, the heated polymer thin film 1005 may be subjected to a uniaxial stress and accordingly stretched in one direction, e.g., a transverse direction (TD), which in the illustrated embodiment may be orthogonal to the machine direction. According to some embodiments, the stretching operation may be performed by guiding the edges of the heated polymer thin film 1005 along guide path 1035 such as by clamping the edges of the polymer thin film to conveyors (not shown) that traverse the guide path 1035. Guide path 1035 may be shaped such that the heated polymer thin film 1005 is in compression during at least a portion of the stretching operation. For instance, the translation velocity in the machine direction of the polymer thin film 1005 within deformation zone 1015 may be less than the translation velocity in pre-heating zone 1010 such that the polymer thin film 1005 may be in compression in the machine direction, e.g., along the full guide path 1035 or along one or more portions of the guide path 1035 within deformation zone 1015.

Furthermore, the temperature of the polymer thin film 1005 may be maintained at a desired temperature before and/or during the act of stretching, i.e., within deformation zone 1015, in order to improve the deformability of the polymer thin film relative to an un-heated polymer thin film. The temperature of the polymer thin film 1005 within deformation zone 1015 may be less than, equal to, or greater than the temperature of the polymer thin film within pre-heating zone 1010.

As will be appreciated, transverse tension and compression along the machine direction may induce buckling, i.e., the formation of wrinkles 1045, in polymer thin film 1005. In example embodiments, wrinkles 1045 may be substantially parallel and may extend along the transverse direction of the polymer thin film 1005.

The transverse tension and accompanying compression along the machine direction may, relative to the initial bulk refractive index (n0), decrease the refractive index of the wrinkled polymer thin film 1006 along the transverse direction and increase the refractive index of the wrinkled polymer thin film 1006 along the machine direction such that n₂<n₀<n₁, where n₁ is the refractive index of the wrinkled polymer thin film 1006 along the machine direction and n₂ is the refractive index of the wrinkled polymer thin film 1006 along the transverse direction orthogonal to the machine direction.

After stretching, the wrinkled polymer thin film 1006 may be disconnected from the conveyors (not shown). In some embodiments, the conveyors may release the wrinkled polymer thin film 1006. In some embodiments, the wrinkled polymer thin film 1006 may be cut to form a cut edge 1040 and accordingly separate the wrinkled polymer thin film 1006 from the conveyors. The wrinkled polymer thin film 1006 may be cooled in cooling region 1020 and may exit system 1000 at exit 1030 as an optically anisotropic polymer thin film 1007.

An example lamination method for forming a polymer thin film having anomalous birefringence is outlined in the flow chart of FIG. 11. At step 1110, a first polymer thin film may be oriented uniaxially. At step 1120, a laminate may be formed by laminating the uniaxially oriented first polymer thin film to a second polymer thin film (or vice versa). At step 1130, the laminate from step 1120 may be uniaxially oriented in a direction transverse to the orientation direction of the first polymer thin film. At step 1140, the first and second polymer thin films may be separated.

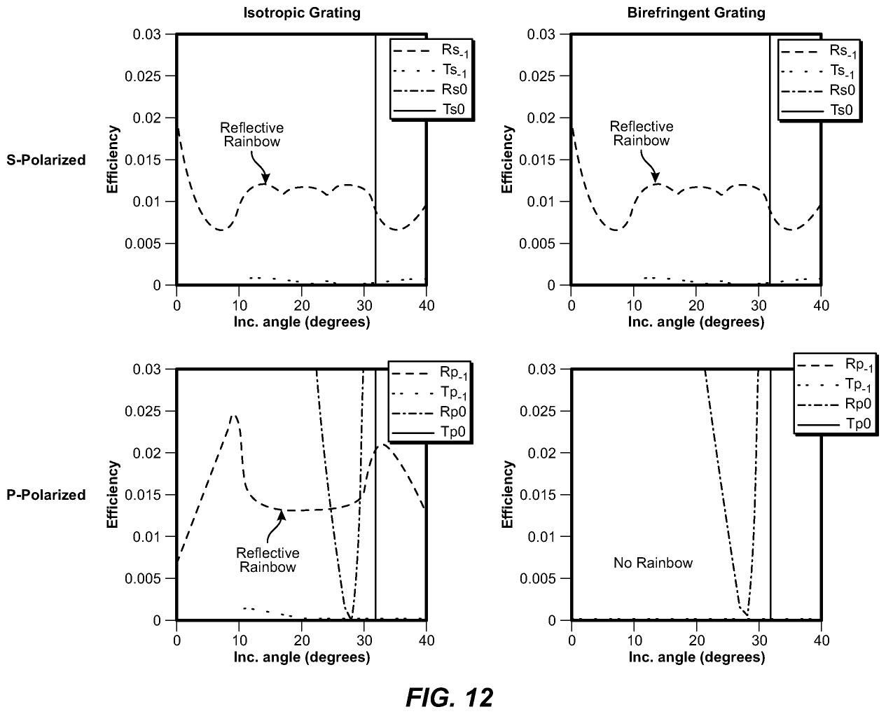

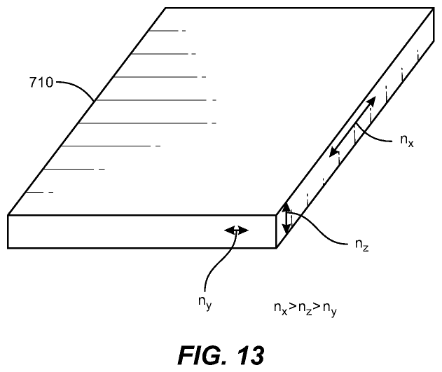

The performance of a diffractive grating having comparative isotropic polymer layers and birefringent polymer layers is shown in FIG. 12. FIG. 13 is a schematic perspective illustration of a polymer thin film characterized by anomalous birefringence, where nₓ>n_{z}>n_{y}.

In accordance with various embodiments, optically anisotropic polymer thin films may include fibrous, amorphous, partially crystalline, or wholly crystalline materials. Such materials may also be mechanically anisotropic, where one or more characteristics including but not limited to compressive strength, tensile strength, shear strength, yield strength, stiffness, hardness, toughness, ductility, machinability, thermal expansion, and creep behavior may be directionally dependent.

A polymer thin film may be laminated to a high Poisson's ratio polymer thin film where the anisotropic mechanical properties of the latter may be used to deform (i.e., stretch) the polymer thin film to achieve a Poisson's ratio in the polymer thin film in excess of the thermodynamic limit. That is, post deformation, the polymer thin film may exhibit a Poisson's ratio greater than approximately 0.5. In some embodiments, during the act of deformation, crystallites within the polymer thin film may be re-oriented along a common direction, which may result in the polymer thin film exhibiting a high degree of optical anisotropy, including an anomalous birefringence.

By way of example, a polymer thin film may be laminated to a high Poisson's ratio polymer thin film using an optically clear adhesive such that the machine direction of the high Poisson's ratio polymer thin film is aligned substantially parallel to the transverse direction of the polymer thin film. In certain embodiments, the polymer thin film and the high Poisson's ratio polymer thin film may each include polyethylene naphthalate. Either or both the polymer thin film and the high Poisson's ratio polymer thin film may be stretched (e.g., uniaxially or biaxially) prior to forming the laminate.

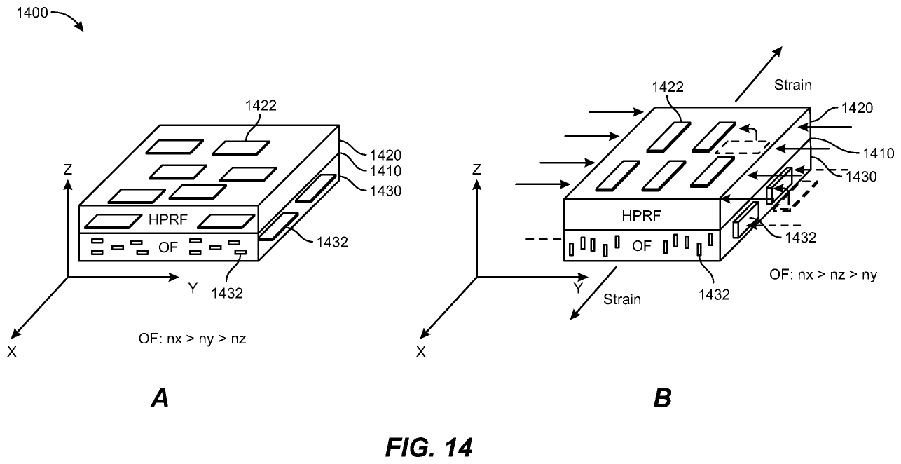

In a state of uniaxially-applied tension, the high Poisson's ratio polymer thin film may induce in the polymer thin film an in-plane compressive strain orthogonal to the applied stress, i.e., where the compressive strain in the laminate is greater than that of the polymer thin film. Such a compressive strain may cause a reorientation of crystallites or polymer chains in the polymer thin film and the realization of greater in-plane birefringence. This response is shown schematically in FIG. 14.

Referring to FIG. 14A, a method 1400 may include forming a laminate 1410 that includes a high Poisson's ratio polymer thin film 1420 bonded to an optical polymer thin film 1430. In some embodiments, the high Poisson's ratio polymer thin film 1420 and the optical polymer thin film 1430 may be formed simultaneously or in succession.

In the as-formed laminate 1410, the Poisson's ratio of the high Poisson's ratio polymer thin film 1420 may be greater than the Poisson's ratio of the optical polymer thin film 1430, e.g., approximately 10% greater, approximately 20% greater, approximately 50% greater, approximately 100% greater, approximately 150% greater, approximately 200% greater, or approximately 300% greater or more, including ranges between any of the foregoing values.

Referring to FIG. 14B, by applying a uniaxial strain to the laminate 1410, e.g., along the x-axis, the attendant transverse contraction in the high Poisson's ratio polymer thin film 1420 along the y-axis may cause crystallites 1422 in the high Poisson's ratio polymer thin film 1420 to rotate in the plane of the thin film 1420 and induce a dimensional change and crystallite realignment in the adjacent optical polymerthin film 1430. In examples where the Poisson's ratio of the optical polymer thin film 1430 is less than the Poisson's ratio of the high Poisson's ratio polymer thin film 1420, the strain induced within the optical polymer thin film 1430 may create lateral compression in the optical polymer thin film 1430, a rotation of crystallites 1432 within the optical polymer thin film 1430 out of the plane of the of the optical polymer thin film 1430 and the creation of anomalous birefringence. In some embodiments, the laminate 1410 may be heated during the act of stretching and crystallite realignment.

Such re-orientation of the crystalline phase within the polymer thin film 1430 may increase the refractive index along the z-axis, i.e., along the thickness dimension of the optical polymer thin film 1430 and create an optical polymer thin film where nₓ>n_{z}>n_{y}. Although not illustrated, after stretching, the optical polymer thin film 1430 may be de-bonded or otherwise separated from the high Poisson's ratio polymer thin film 1420.

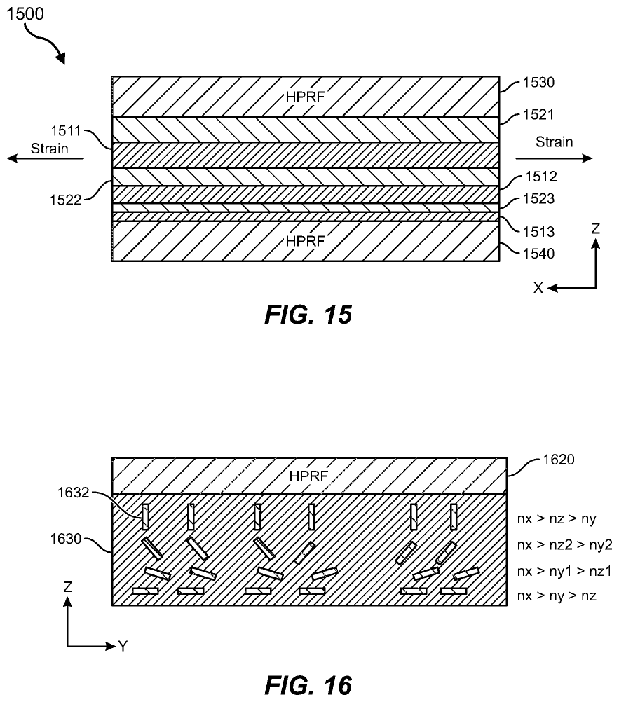

FIG. 15 is a cross-sectional view of a process to fabricate high birefringence multilayer reflective polarizer according to various embodiments. The reflective polarizer 1500 may include a stack of alternating primary and secondary polymer thin films, which are disposed at an intermediate stage of fabrication between an upper high Poisson's ratio polymer thin film 1530 and a lower high Poisson's ratio polymer thin film 1540. The primary polymer thin films 1511, 1512, 1513, which are collectively referred to herein as primary polymer thin films 1510, may each include an optically anisotropic polymer thin film whereas the secondary polymer thin films 1521, 1522, 1523, which are collectively referred to herein as secondary polymer thin films 1520, may each include an optically isotropic polymer thin film.

Following application of an applied strain, optically anisotropic polymer layers 1510 and optically isotropic polymer layers 1520 may have different refractive indices along a first in-plane direction (e.g., x-axis direction), and refractive indices along a second in-plane direction (e.g., y-axis direction) orthogonal to the first in-plane direction that are substantially matched. According to some embodiments, the lower in-plane index of the anisotropic layers may be lattice matched to the in-plane indices of the isotropic layers. Optically anisotropic polymer thin films 1510 may be characterized by an anomalous birefringence, e.g., where nₓ>n_{z}>n_{y}. In various examples, the in-plane birefringence (nₓ−n_{y}) may be at least approximately 0.05, e.g., approximately 0.05, approximately 0.1, approximately 0.12, approximately 0.14, approximately 0.16, approximately 0.18, approximately 0.20, approximately 0.22, or greater, including ranges between any of the foregoing values.

As illustrated schematically in FIG. 15, according to some embodiments, the thickness of each successive layer 1510, 1520 may decrease, e.g., from top to bottom, throughout the stack, which may increase the wavelength range of the associated reflectance spectrum. Following application of the strain, upper and lower high Poisson's ratio polymer thin films 1530, 1540 may be removed from the multilayer structure. Furthermore, although the illustrated stack of primary and secondary polymer thin films is shown to include 6 total layers, it will be appreciated that fewer or a greater number of alternating layers may be used.

In crystalline or semi-crystalline optical polymer thin films, the optical anisotropy may be correlated to the degree or extent of crystallite orientation, whereas the degree or extent of chain entanglement may create comparable optical anisotropy in amorphous optical polymer thin films. An example semi-crystalline optical polymer thin film having a non-uniform, i.e., spatially localized, orientation of crystallites is shown schematically in FIG. 16. In the illustrated embodiment, an adjacent high Poisson's ratio polymer thin film 1620 may induce a localized reorientation of crystallites 1632 within polymer thin film 1630 such that the extent of reorientation (i.e., rotation) is greater in regions of the polymer thin film 1630 proximate to the high Poisson's ratio polymer thin film 1620. That is, the polymer thin film 1630 may exhibit anomalous birefringence (nₓ>n_{z}>n_{y}) in regions adjacent to the high Poisson's ratio polymer thin film 1620.

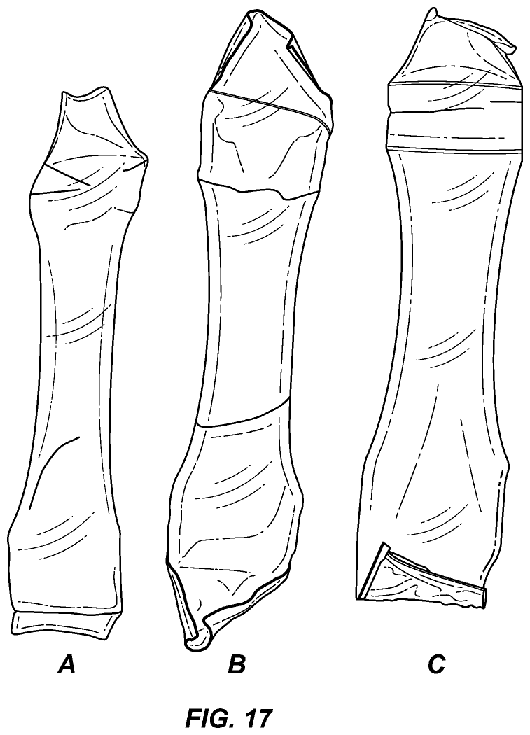

Referring to FIG. 17, shown is an optical micrograph of example polymer thin film-high Poisson's ratio polymer thin film laminates after heating to approximately 130° C. and the application of a uniaxial strain of (A) approximately 70%, (B) approximately 60%, and (C) approximately 40%.

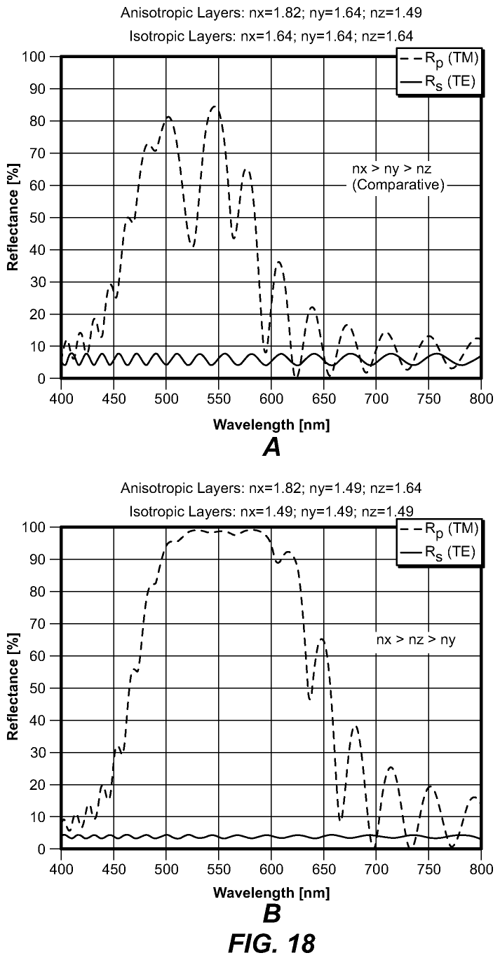

Modeled plots of reflectance versus wavelength are shown in FIG. 18 for example multilayer reflective polarizers. For incident light have a wavelength of 500 nm, the performance of a comparative architecture having 25 total bi-layers, a total thickness of 3.8 micrometers, and including alternating optically anisotropic layers characterized by nₓ>n_{y}>n_{z} is shown in FIG. 18A, whereas the performance of a reflective polarizer architecture having 25 total bi-layers, a total thickness of 4.2 micrometers, and including alternating optically anisotropic layers characterized by nₓ>n_{z}>n_{y} is shown in FIG. 18B. As will be appreciated, and with particular reference to FIG. 18B, the polarizer having isotropic layers that alternate with anomalously birefringent layers exhibits better selectivity over a broader wavelength band with respect to the comparative structure.

In certain embodiments, in a multilayer architecture having isotropic layers that alternate with anomalously birefringent layers, the in-plane refractive index difference between the isotropic and the anisotropic layers along one direction (e.g., the x-direction) may be at least approximately 0.2, e.g., approximately 0.2, approximately 0.22, approximately 0.24, approximately 0.26, approximately 0.28, approximately 0.30, approximately 0.32, or approximately 0.34, including ranges between any of the foregoing values, whereas the in-plane refractive index difference between the isotropic and the anisotropic layers along a complementary direction (e.g., the y-direction) may be zero.

Such a structure may be used to manufacture a reflective polarizer having an overall lower total thickness, including a fewer number of bi-layers, than comparative structures while decreasing the amount of scattered and absorbed light. In such structures, Rₚ (%) may be significantly greater than Rₛ (%). For instance, in example structures, Rₚ−Rₛ may be at least approximately 85%, e.g., approximately 85%, approximately 90%, approximately 92%, or approximately 94%, including ranges between any of the foregoing values, over a wavelength band having a width of at least approximately 50 nm, e.g., approximately 50 nm, approximately 75 nm, or approximately 100 nm, including ranges between any of the foregoing values.

As disclosed herein, an optically anisotropic polymer thin film may be characterized by disparate refractive indices along its three major axes (i.e., length, width, and thickness). Such a polymer thin film may be anomalously birefringent and may include in-plane refractive indices (nₓ and n_{y}) and a through-thickness refractive index (n_{z}), where nₓ>n_{z}>n_{y}. In certain embodiments, nₓ>1.7, e.g., approximately 1.75, approximately 1.8, approximately 1.85, approximately 1.9, approximately 1.95, or approximately 2.0, including ranges between any of the foregoing values. Example polymer compositions may include polyethylene naphthalate (PEN) or polyethylene terephthalate (PET), although further polymer compositions are contemplated.

According to further embodiments, disclosed is a method of manufacturing an anisotropic polymer thin film having a Poisson's (v) ratio greater than 0.5. Whereas the Poisson's ratio for isotropic materials is thermodynamically constrained to −1≤v≤0.5, and most polymers exhibit a Poisson's ratio within a range of approximately 0.2 to approximately 0.3, Applicants have demonstrated that the deformation of a semi-crystalline polymer and the attendant strain-induced realignment of crystals within the polymer can generate a highly anisotropic polymer thin film.

An example method for achieving a Poisson's ratio greater than 0.5 includes forming a polymer thin film having a polymer matrix and a plurality of crystals dispersed throughout the matrix, where the crystals are at least partially aligned with respect to an in-plane dimension of the polymer thin film, and applying a tensile stress to the polymer thin film along a direction substantially orthogonal to the alignment direction of the crystals to deform the polymer thin film and realign the crystals.

A method of forming an optical quality polymer thin film having anomalous birefringence may include (a) forming a laminate having a high Poisson's ratio polymer thin film disposed directly over a semi-crystalline optical polymer thin film, and (b) applying an in-plane uniaxial tensile stress to the high Poisson's ratio polymer thin film to form an anomalously birefringent optical polymer thin film.

### EXAMPLE EMBODIMENTS

Example 1: A polymer thin film includes a first in-plane refractive index (nₓ) along a first direction of the polymer thin film, a second in-plane refractive index (n_{y}) along a second direction of the polymer thin film orthogonal to the first direction, and a third refractive index (n_{z}) along a thickness direction substantially orthogonal to both the first direction and the second direction, where nₓ>n_{z}>n_{y}.

Example 2: The polymer thin film of Example 1, where nₓ is greater than approximately 1.7.

Example 3: The polymer thin film of any of Examples 1 and 2, where (nₓ−n_{y}) is greater than approximately 0.05.

Example 4: The polymer thin film of any of Examples 1-3, where (nₓ−n_{y}) is greater than approximately 0.2.

Example 5: The polymer thin film of any of Examples 1-4, where (nₓ−n_{y}) is variable along the thickness direction.

Example 6: The polymer thin film of any of Examples 1-5, including a polymer selected from polyethylene naphthalate, polyethylene terephthalate, polybutylene naphthalate, and polybutylene terephthalate.

Example 7: The polymer thin film of Example 6, where the polymer includes a crystalline phase.

Example 8: A method includes forming a polymer thin film including a polymer matrix and a plurality of crystals dispersed throughout the matrix, where the crystals are at least partially aligned with respect to a first in-plane dimension of the polymer thin film, and applying a tensile stress to the polymer thin film along a direction substantially orthogonal to the alignment direction of the crystals to deform the polymer thin film and realign the crystals.

Example 9: The method of Example 8, where the polymer matrix includes a polymer selected from polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, and polyethylene.

Example 10: The method of any of Examples 8 and 9 where the crystals include polyethylene naphthalate or polyethylene terephthalate.

Example 11: The method of any of Examples 8-10, where the realigned crystals are at least partially aligned with respect to a second in-plane dimension of the polymer thin film.

Example 12: The method of any of Examples 8-11, further including heating the polymer thin film to a temperature greater than a glass transition temperature of the polymer matrix while applying the tensile stress.

Example 13: The method of any of Examples 8-12, where the realigned crystals are at least partially aligned with respect to the direction of the applied tensile stress.

Example 14: A multilayer polymer composite includes alternating layers of anisotropic and isotropic polymers, where the anisotropic polymer layers are each characterized by an in-plane birefringence of at least approximately 0.05.

Example 15: The multilayer polymer composite of Example 14, where an in-plane refractive index of at least one of the anisotropic polymer layers is at least approximately 1.7.

Example 16: The multilayer polymer composite of any of Examples 14 and 15, where at least one of the anisotropic polymer layers includes (a) a first in-plane refractive index (nₓ) along a first direction, (b) a second in-plane refractive index (n_{y}) along a second direction orthogonal to the first direction, and (c) a third refractive index (n_{z}) along a thickness direction substantially orthogonal to both the first direction and the second direction, where nₓ>n_{z}>n_{y}.

Example 17: The multilayer polymer composite of any of Examples 14-16, where at least one of the anisotropic polymer layers includes a polymer selected from polyethylene naphthalate, polyethylene terephthalate, polybutylene naphthalate, and polybutylene terephthalate.

Example 18: The multilayer polymer composite of any of Examples 14-17, where at least one of the anisotropic polymer layers includes a crystalline phase.

Example 19: The multilayer polymer composite of any of Examples 14-18, where at least one of the isotropic polymer layers includes a polymer selected from isotropic polyesters and isotropic poly (methyl methacrylate).

Example 20: The multilayer polymer composite of any of Examples 14-19, where a thickness of the anisotropic polymer layers and a thickness of the isotropic polymer layers each progressively decrease along a thickness dimension of the composite.

Example 21: A method includes forming a laminate including a high Poisson's ratio polymer thin film disposed directly over an optical polymer thin film, heating the laminate to a temperature greater than a glass transition temperature of the optical polymer thin film, and applying an in-plane uniaxial tensile stress to the laminate.

Example 22: A polymer thin film characterized by a Poisson's ratio of greater than approximately 0.5.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 1900 in FIG. 19) or that visually immerses a user in an artificial reality (e.g., virtual-reality system 2000 in FIG. 20). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 19, augmented-reality system 1900 may include an eyewear device 1902 with a frame 1910 configured to hold a left display device 1915(A) and a right display device 1915(B) in front of a user's eyes. Display devices 1915(A) and 1915(B) may act together or independently to present an image or series of images to a user. While augmented-reality system 1900 includes two displays, embodiments of this disclosure may be implemented in augmented-reality systems with a single NED or more than two NEDs.

In some embodiments, augmented-reality system 1900 may include one or more sensors, such as sensor 1940. Sensor 1940 may generate measurement signals in response to motion of augmented-reality system 1900 and may be located on substantially any portion of frame 1910. Sensor 1940 may represent a position sensor, an inertial measurement unit (IMU), a depth camera assembly, a structured light emitter and/or detector, or any combination thereof. In some embodiments, augmented-reality system 1900 may or may not include sensor 1940 or may include more than one sensor. In embodiments in which sensor 1940 includes an IMU, the IMU may generate calibration data based on measurement signals from sensor 1940. Examples of sensor 1940 may include, without limitation, accelerometers, gyroscopes, magnetometers, other suitable types of sensors that detect motion, sensors used for error correction of the IMU, or some combination thereof.

Augmented-reality system 1900 may also include a microphone array with a plurality of acoustic transducers 1920(A)-1920(J), referred to collectively as acoustic transducers 1920. Acoustic transducers 1920 may be transducers that detect air pressure variations induced by sound waves. Each acoustic transducer 1920 may be configured to detect sound and convert the detected sound into an electronic format (e.g., an analog or digital format). The microphone array in FIG. 19 may include, for example, ten acoustic transducers: 1920(A) and 1920(B), which may be designed to be placed inside a corresponding ear of the user, acoustic transducers 1920(C), 1920(D), 1920(E), 1920(F), 1920(G), and 1920(H), which may be positioned at various locations on frame 1910, and/or acoustic transducers 1920(I) and 1920(J), which may be positioned on a corresponding neckband 1905.

In some embodiments, one or more of acoustic transducers 1920(A)-(F) may be used as output transducers (e.g., speakers). For example, acoustic transducers 1920(A) and/or 1920(B) may be earbuds or any other suitable type of headphone or speaker.

The configuration of acoustic transducers 1920 of the microphone array may vary. While augmented-reality system 1900 is shown in FIG. 19 as having ten acoustic transducers 1920, the number of acoustic transducers 1920 may be greater or less than ten. In some embodiments, using higher numbers of acoustic transducers 1920 may increase the amount of audio information collected and/or the sensitivity and accuracy of the audio information. In contrast, using a lower number of acoustic transducers 1920 may decrease the computing power required by an associated controller 1950 to process the collected audio information. In addition, the position of each acoustic transducer 1920 of the microphone array may vary. For example, the position of an acoustic transducer 1920 may include a defined position on the user, a defined coordinate on frame 1910, an orientation associated with each acoustic transducer 1920, or some combination thereof.

Acoustic transducers 1920(A) and 1920(B) may be positioned on different parts of the user's ear, such as behind the pinna, behind the tragus, and/or within the auricle or fossa. Or, there may be additional acoustic transducers 1920 on or surrounding the ear in addition to acoustic transducers 1920 inside the ear canal. Having an acoustic transducer 1920 positioned next to an ear canal of a user may enable the microphone array to collect information on how sounds arrive at the ear canal. By positioning at least two of acoustic transducers 1920 on either side of a user's head (e.g., as binaural microphones), augmented-reality device 1900 may simulate binaural hearing and capture a 3D stereo sound field around about a user's head. In some embodiments, acoustic transducers 1920(A) and 1920(B) may be connected to augmented-reality system 1900 via a wired connection 1930, and in other embodiments acoustic transducers 1920(A) and 1920(B) may be connected to augmented-reality system 1900 via a wireless connection (e.g., a Bluetooth connection). In still other embodiments, acoustic transducers 1920(A) and 1920(B) may not be used at all in conjunction with augmented-reality system 1900.

Acoustic transducers 1920 on frame 1910 may be positioned along the length of the temples, across the bridge, above or below display devices 1915(A) and 1915(B), or some combination thereof. Acoustic transducers 1920 may be oriented such that the microphone array is able to detect sounds in a wide range of directions surrounding the user wearing the augmented-reality system 1900. In some embodiments, an optimization process may be performed during manufacturing of augmented-reality system 1900 to determine relative positioning of each acoustic transducer 1920 in the microphone array.

In some examples, augmented-reality system 1900 may include or be connected to an external device (e.g., a paired device), such as neckband 1905. Neckband 1905 generally represents any type or form of paired device. Thus, the following discussion of neckband 1905 may also apply to various other paired devices, such as charging cases, smart watches, smart phones, wrist bands, other wearable devices, hand-held controllers, tablet computers, laptop computers, other external compute devices, etc.

As shown, neckband 1905 may be coupled to eyewear device 1902 via one or more connectors. The connectors may be wired or wireless and may include electrical and/or non-electrical (e.g., structural) components. In some cases, eyewear device 1902 and neckband 1905 may operate independently without any wired or wireless connection between them. While FIG. 19 illustrates the components of eyewear device 1902 and neckband 1905 in example locations on eyewear device 1902 and neckband 1905, the components may be located elsewhere and/or distributed differently on eyewear device 1902 and/or neckband 1905. In some embodiments, the components of eyewear device 1902 and neckband 1905 may be located on one or more additional peripheral devices paired with eyewear device 1902, neckband 1905, or some combination thereof.

Pairing external devices, such as neckband 1905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1900 may be provided by a paired device or shared between a paired device and an eyewear device, thus reducing the weight, heat profile, and form factor of the eyewear device overall while still retaining desired functionality. For example, neckband 1905 may allow components that would otherwise be included on an eyewear device to be included in neckband 1905 since users may tolerate a heavier weight load on their shoulders than they would tolerate on their heads. Neckband 1905 may also have a larger surface area over which to diffuse and disperse heat to the ambient environment. Thus, neckband 1905 may allow for greater battery and computation capacity than might otherwise have been possible on a stand-alone eyewear device. Since weight carried in neckband 1905 may be less invasive to a user than weight carried in eyewear device 1902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1905 may be communicatively coupled with eyewear device 1902 and/or to other devices. These other devices may provide certain functions (e.g., tracking, localizing, depth mapping, processing, storage, etc.) to augmented-reality system 1900. In the embodiment of FIG. 19, neckband 1905 may include two acoustic transducers (e.g., 1920(I) and 1920(J)) that are part of the microphone array (or potentially form their own microphone subarray). Neckband 1905 may also include a controller 1925 and a power source 1935.

Acoustic transducers 1920(I) and 1920(J) of neckband 1905 may be configured to detect sound and convert the detected sound into an electronic format (analog or digital). In the embodiment of FIG. 19, acoustic transducers 1920(I) and 1920(J) may be positioned on neckband 1905, thereby increasing the distance between the neckband acoustic transducers 1920(I) and 1920(J) and other acoustic transducers 1920 positioned on eyewear device 1902. In some cases, increasing the distance between acoustic transducers 1920 of the microphone array may improve the accuracy of beamforming performed via the microphone array. For example, if a sound is detected by acoustic transducers 1920(C) and 1920(D) and the distance between acoustic transducers 1920(C) and 1920(D) is greater than, e.g., the distance between acoustic transducers 1920(D) and 1920(E), the determined source location of the detected sound may be more accurate than if the sound had been detected by acoustic transducers 1920(D) and 1920(E).

Controller 1925 of neckband 1905 may process information generated by the sensors on neckband 1905 and/or augmented-reality system 1900. For example, controller 1925 may process information from the microphone array that describes sounds detected by the microphone array. For each detected sound, controller 1925 may perform a direction-of-arrival (DOA) estimation to estimate a direction from which the detected sound arrived at the microphone array. As the microphone array detects sounds, controller 1925 may populate an audio data set with the information. In embodiments in which augmented-reality system 1900 includes an inertial measurement unit, controller 1925 may compute all inertial and spatial calculations from the IMU located on eyewear device 1902. A connector may convey information between augmented-reality system 1900 and neckband 1905 and between augmented-reality system 1900 and controller 1925. The information may be in the form of optical data, electrical data, wireless data, or any other transmittable data form. Moving the processing of information generated by augmented-reality system 1900 to neckband 1905 may reduce weight and heat in eyewear device 1902, making it more comfortable to the user.

Power source 1935 in neckband 1905 may provide power to eyewear device 1902 and/or to neckband 1905. Power source 1935 may include, without limitation, lithium ion batteries, lithium-polymer batteries, primary lithium batteries, alkaline batteries, or any other form of power storage. In some cases, power source 1935 may be a wired power source. Including power source 1935 on neckband 1905 instead of on eyewear device 1902 may help better distribute the weight and heat generated by power source 1935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 2000 in FIG. 20, that mostly or completely covers a user's field of view. Virtual-reality system 2000 may include a front rigid body 2002 and a band 2004 shaped to fit around a user's head. Virtual-reality system 2000 may also include output audio transducers 2006(A) and 2006(B). Furthermore, while not shown in FIG. 20, front rigid body 2002 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 1900 and/or virtual-reality system 2000 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 1900 and/or virtual-reality system 2000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 1900 and/or virtual-reality system 2000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 20, output audio transducers 2006(A) and 2006(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 19, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a polymer thin film that comprises or includes polyethylene naphthalate include embodiments where a polymer thin film consists essentially of polyethylene naphthalate and embodiments where a polymer thin film consists of polyethylene naphthalate.

What is claimed is:

1. A polymer thin film comprising:
a first in-plane refractive index (nₓ) along a first direction of the polymer thin film;
a second in-plane refractive index (n_{y}) along a second direction of the polymer thin film orthogonal to the first direction; and
a third refractive index (n_{z}) along a thickness direction substantially orthogonal to both the first direction and the second direction, where nₓ>n_{z}>n_{y}.

2. The polymer thin film of claim 1, wherein nₓ is greater than approximately 1.7.

3. The polymer thin film of claim 1, wherein (nₓ−n_{y}) is greater than approximately 0.05.

4. The polymer thin film of claim 1, wherein (nₓ−n_{y}) is greater than approximately 0.2.

5. The polymer thin film of claim 1, wherein (nₓ−n_{y}) is variable along the thickness direction.

6. The polymer thin film of claim 1, comprising a polymer selected from the group consisting of polyethylene naphthalate, polyethylene terephthalate, polybutylene naphthalate, and polybutylene terephthalate.

7. The polymer thin film of claim 6, wherein the polymer comprises a crystalline phase.

8. A method comprising:
forming a polymer thin film comprising a polymer matrix and a plurality of crystals dispersed throughout the matrix, wherein the crystals are at least partially aligned with respect to a first in-plane dimension of the polymer thin film; and
applying a tensile stress to the polymerthin film along a direction substantially orthogonal to the alignment direction of the crystals to deform the polymer thin film and realign the crystals.

9. The method of claim 8, wherein the polymer matrix comprises a polymer selected from the group consisting of polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, and polyethylene.

10. The method of claim 8, wherein the crystals comprise polyethylene naphthalate or polyethylene terephthalate.

11. The method of claim 8, wherein the realigned crystals are at least partially aligned with respect to a second in-plane dimension of the polymer thin film.

12. The method of claim 8, further comprising heating the polymer thin film to a temperature greater than a glass transition temperature of the polymer matrix while applying the tensile stress.

13. The method of claim 8, wherein the realigned crystals are at least partially aligned with respect to the direction of the applied tensile stress.

14. A multilayer polymer composite comprising:
alternating layers of anisotropic and isotropic polymers, wherein the anisotropic polymer layers each comprise an in-plane birefringence of at least approximately 0.05.

15. The multilayer polymer composite of claim 14, wherein an in-plane refractive index of at least one of the anisotropic polymer layers is at least approximately 1.7.

16. The multilayer polymer composite of claim 14, wherein at least one of the anisotropic polymer layers comprises:
a first in-plane refractive index (nₓ) along a first direction;
a second in-plane refractive index (n_{y}) along a second direction orthogonal to the first direction; and
a third refractive index (n_{z}) along a thickness direction substantially orthogonal to both the first direction and the second direction, where nₓ>n_{z}>n_{y}.

17. The multilayer polymer composite of claim 14, wherein at least one of the anisotropic polymer layers comprises a polymer selected from the group consisting of polyethylene naphthalate, polyethylene terephthalate, polybutylene naphthalate, and polybutylene terephthalate.

18. The multilayer polymer composite of claim 14, wherein at least one of the anisotropic polymer layers comprises a crystalline phase.

19. The multilayer polymer composite of claim 14, wherein at least one of the isotropic polymer layers comprises a polymer selected from the group consisting of isotropic polyesters and isotropic poly (methyl methacrylate).

20. The multilayer polymer composite of claim 14, wherein a thickness of the anisotropic polymer layers and a thickness of the isotropic polymer layers each progressively decrease along a thickness dimension of the composite.
